(19) United States
(12) Patent Application Publication
(10) Pub. No.: US 2005/0217125 A1
(43) Pub. Date: Oct. 6, 2005

(54) Pencil sharpener, especially for cosmetic soft leaded pencils

(76) Inventor: Ernst Fischer, Langensendelbach/Brauningshof (DE)

Correspondence Address: Richard C Woodbridge;Synnestvedt Lechner & Woodbridge, P O Box 592, Princeton, NJ, 08542-0592, US

(21) Appl. No.: 10/512,326

(22) PCT Filed: Apr. 25, 2003
(86) PCT No.: PCT/DE03/01346

§ 371 Date: Apr. 14, 2005

(30) Foreign Application Priority Data
Apr. 25, 2002 (DE) 102 18 357.0

(51) Int. Cl. B43L 23/00

(52) U.S. Cl. 30/457; 30/452

(57) ABSTRACT

There is described a sharpener, in particular for cosmetic soft lead pencils, comprising a conical sharpener passage (10) and a sharpener blade (12) which is set approximately tangentially with respect to the sharpener passage (10) and which includes a clearance angle (18) with the sharpener passage (10). In order to achieve an excellent cutting behaviour or to avoid unwanted chatter during the cutting operation, the sharpener blade (12) includes with the sharpener passage (10) a clearance angle (18, 18′, 18″) which becomes continuously greater towards the tapering front end (20) of the sharpener passage (10).

The invention concerns a sharpener, in particular for cosmetic soft lead pencils, comprising a conical sharpener passage and a sharpener blade which is set approximately tangentially with respect to the sharpener passage and which includes a clearance angle with the sharpener passage.

DE 91 04 844 U1 discloses a pencil sharpener, wherein the cutting edge of the sharpener blade is of a configuration in accordance with a parabola which is disposed in a plane parallel to the tangential plane of a generatrix of the conical sharpener passage for the pencil to be sharpened. The production of such a pencil sharpener with a parabolic cutting edge is complicated, and for that reason such a pencil sharpener was unable to achieve successful market penetration.

DE 1 511 454 A describes a lead sharpener comprising two plates which cross each other in a scissor-like configuration and which are mounted freely rotatably at an equal distance and height from a lead guide tube and of which at least one plate has a cutting edge. That lead sharpener involves a sharpener for sharpening the lead for example of a retractable pencil and not a sharpener for sharpening a pencil with a lead which is fixed in a sheath.

Cosmetic soft lead pencils usually have a pasty lead of relatively large diameter and a sheath which protects the lead. The sheath can comprise wood but in more recent times the sheath is usually made from a suitable plastic material.

In the case of known sharpeners of the kind set forth in the opening part of this specification, for cosmetic soft lead pencils, the sharpener blade is arranged in such a way that it includes a constant clearance angle with the sharpener passage along the sharpener passage. Adopting the terminology used in relation to turning tools, the clearance angle is the angle between the tangential plane of the conical sharpener passage, which plane is determined by the blade cutting edge, and the rear face of the sharpener blade. Particularly in the case of soft lead pencils with a sheath comprising a plastic material, a chattering cutting behaviour is exhibited in that situation during the sharpening procedure. That chattering cutting characteristic is perceived as being a nuisance.

A sharpener for sheathed pencils with a soft lead, that is to say a sharpener of the kind set forth in the opening part of this specification for cosmetic soft lead pencils, is known for example from DE 1 236 374 B. In that known sharpener, the sharpener blade is arranged in such a way that its blade cutting edge is disposed in coincident relationship with the longitudinal center line of the conical sharpener passage—as viewed in projection—so that the clearance angle between the cutting blade and the sharpener passage is constant along the sharpener passage. That results in the above-mentioned undesirable chatter phenomenon. A corresponding consideration also applies for example to the sharpener known from DE 7 027 544 U1. In that sharpener also the cutting blade includes a constant clearance angle with the sharpener passage, along the sharpener passage.

The object of the present invention is to provide a sharpener of the kind set forth in the opening part of this specification, in which an unwanted chatter cutting behaviour is easily avoided during the sharpening operation—particularly when dealing with soft lead pencils with a plastic sheath.

In a sharpener of the kind set forth in the opening part of this specification, that object is attained in accordance with the invention in that the sharpener blade includes with the sharpener passage a clearance angle which becomes continuously greater towards the tapering front end of the sharpener passage. By virtue of such a configuration, that is to say the arrangement of the cutting blade in relation to the sharpener passage, the soft lead pencil to be sharpened is virtually pulled to the front end of the sharpener passage during the sharpening operation, in which case unwanted chatter is reliably avoided. Consequently the sharpener according to the invention affords a smooth clean cutting characteristic. That applies both in respect of soft lead pencils with a wood sheath and also in relation to soft lead pencils with a plastic sheath.

In comparison with soft lead pencils having a wood sheath soft lead pencils with a plastic sheath also enjoy the advantages that a plastic sheath can be comparatively easily produced in an extrusion process and that, in comparison with a wood sheath, a plastic sheath can also be of a smaller wall thickness because there is no glueing of sheath halves, as is usual in the case of a wood sheath.

In the case of the sharpener according to the invention the cutting edge of the sharpener blade can be oriented in parallel relationship with the longitudinal center line of the conical sharpener passage and can be displaced laterally, that is to say forwardly in the sharpener direction of rotation, in relation to the longitudinal center line—as viewed in projection. Such an arrangement of the sharpener blade or its cutting edge in relation to the conical sharpener passage provides that the sharpener blade, with the sharpener passage, includes a clearance angle which becomes continuously greater towards the tapering front end of the sharpener passage.

Another possibility provides that the cutting edge of the sharpener blade includes with the longitudinal center line of the conical sharpener passage—as viewed in projection—a small acute angle which enlarges towards the front end of the sharpener passage. That small angle can be of the order of magnitude of between 2 and 5°, for example 2.5°.

In a sharpener according to the invention of the last-mentioned kind the cutting blade can be arranged in such a way that the cutting edge of the blade intersects the longitudinal center line of the conically tapering sharpener passage—as viewed in projection—at the beginning of the sharpener passage at a small acute angle. Likewise it is possible that the cutting blade is arranged displaced forwardly in the sharpener direction of rotation relative to the longitudinal center line of the sharpener passage in such a way that the notional prolongation of the blade cutting edge intersects the longitudinal center line of the conically tapering sharpener passage—as viewed in projection—before the beginning of the sharpener passage at a small acute angle.

Such configurations of the sharpener, that is to say such arrangements of the cutting blade or its cutting edge in relation to the conical sharpener passage also make it possible to provide that the sharpener blade, with the sharpener passage, includes a clearance angle which becomes continuously greater towards the tapering front end of the sharpener passage.

In the sharpener according to the invention it is preferred if a guide portion of constant diameter adjoins the conical sharpener passage at the rear end, that is to say at its beginning. In that case the diameter of the guide portion is preferably adapted to the outside diameter of the sheath of the cosmetic pencil to be sharpened. For example the sharpener in accordance with above-mentioned DE 1 236 374 B also has such a guide portion of constant diameter.

Preferably a forming blade is provided at the front end of the conical sharpener passage of the sharpener according to the invention. Such a forming blade makes it possible for the pasty lead of the cosmetic pencil which is to be sharpened to be formed as desired, that is to say for example rounded off. The sharpener in accordance with DE 1 236 374 B which has been referred to on a number of occasions also has for example a forming blade.

Embodiments by way of example of the sharpener according to the invention, in comparison with known sharpeners for cosmetic soft lead pencils, are illustrated in the drawing and described hereinafter, in which respect it is only the conical sharpener passage and the sharpener blade with its cutting edge that are shown in each case.

In the drawing:

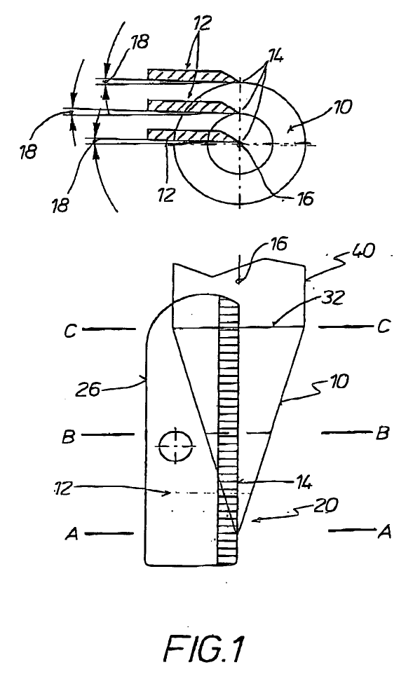

FIG. 1 shows a first embodiment of a known sharpener as a plan view and in three sections taken along section lines A-A, B-B and C-C through the sharpener blade and the conical sharpener passage,

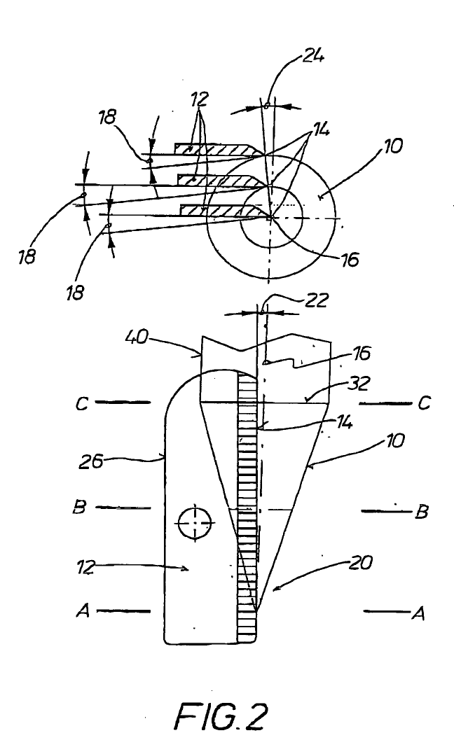

FIG. 2 is a view similar to FIG. 1 of a second embodiment of a known sharpener with corresponding sections taken along section lines A-A, B-B and C-C through the sharpener blade and the sharpener passage,

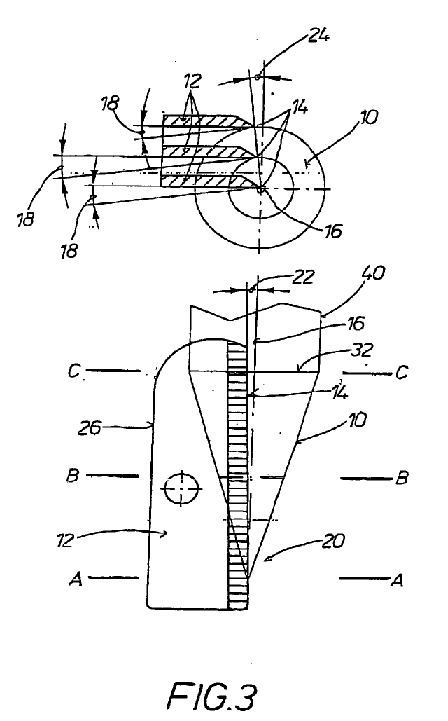

FIG. 3 is a view similar to FIGS. 1 and 2 of a third embodiment of a known sharpener and the sections taken along section lines A-A, B-B and C-C through the sharpener blade and the sharpener passage,

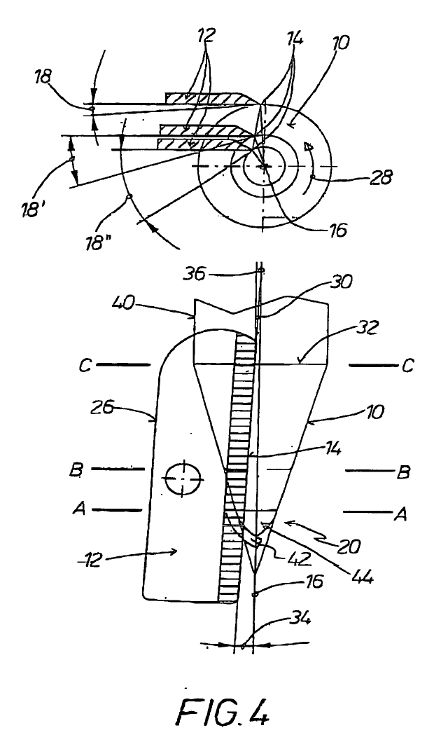

FIG. 4 is a view similar to FIGS. 1 through 3 of a first embodiment of the sharpener according to the invention and three sections similar to the sections shown in FIGS. 1 through 3, taken along section lines A-A, B-B and C-C through the sharpener blade and the sharpener passage,

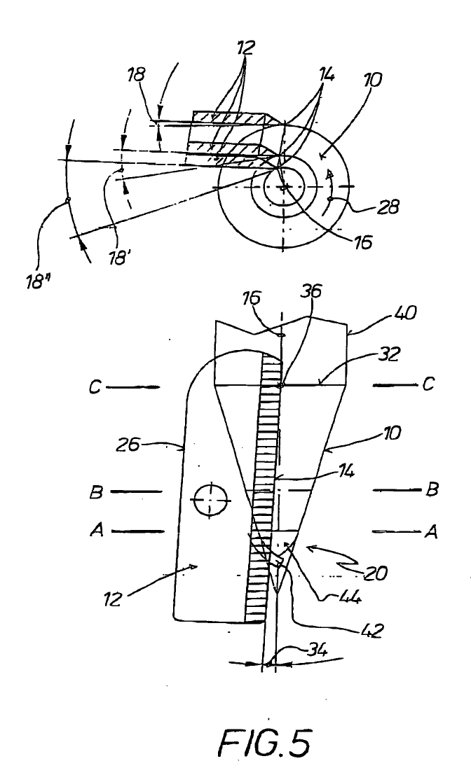

FIG. 5 is a view similar to FIGS. 1 through 4 of a second embodiment of the sharpener according to the invention and three sections taken along section lines A-A, B-B and C-C, similar to the sections taken along section lines A-A, B-B and C-C in FIG. 4, and

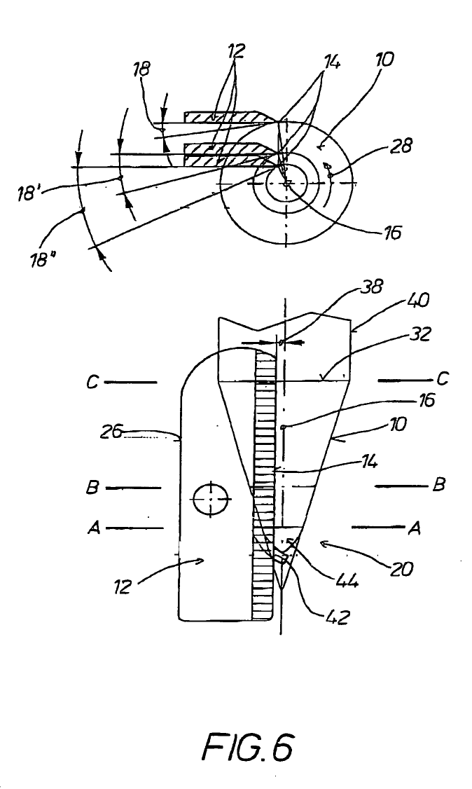

FIG. 6 is a view similar to FIGS. 1 through 5 to show a third embodiment of a sharpener according to the invention and three sections taken along the section lines A-A, B-B and C-C, similar to the sections taken along the section lines A-A, B-B and C-C as shown in FIGS. 4 and 5.

FIG. 1 diagrammatically shows as a plan view and in three sections taken along section lines A-A, B-B and C-C a conical sharpener passage 10 and a sharpener blade 12 which is set approximately tangentially with respect to the sharpener passage 10. The sharpener blade 12 has a blade cutting edge 14. The blade cutting edge 14 is arranged in coincident relationship with respect to the longitudinal center line 16 of the conical sharpener passage 10—as viewed in projection—so that the cutting edge 14 of the sharpener blade 12 includes a constant clearance angle 18 with the sharpener passage 10, along the entire sharpener passage 10. The clearance angle 18 is the angle between the tangential plane of the conical sharpener passage 10, such plane being defined by the cutting edge 14, and the rear face of the sharpener blade 12. That clearance angle 18 is for example of the order of magnitude of 2.5°.

FIG. 2 shows a second configuration of a known sharpener with a conical sharpener passage 10 and a sharpener blade 12 whose cutting edge 14—as viewed in projection—, in relation to the longitudinal center line 16 of the conical sharpener passage 10, includes an acute angle 22 which enlarges rearwardly from the front end 20 of the conical sharpener passage 10. In such a configuration, the clearance angle 18 between the rear face of the cutting blade 12 and the tangential plane of the conical sharpener passage 10 is constant along the conical sharpener passage 10. In such a configuration the clearance angle 18 is for example of the order of magnitude of 7° if the acute angle 22 between the projection of the blade cutting edge 14 and the longitudinal center line 16 is of the order of magnitude of for example 2°. A relatively large clearance angle 18 is wanted in order to achieve a suitable cutting characteristic.

The angle identified by reference numeral 24 in FIG. 2 and the clearance angle 18 which is constant along the conical sharpener passage 10 are of equal magnitude.

FIG. 3 diagrammatically shows a third embodiment of a known sharpener with a conical sharpener passage 10 and a sharpener blade 12 with a cutting edge 14 whose projection again includes an acute angle 22 corresponding to FIG. 2, with the longitudinal center line 16 of the conical sharpener passage 10. The configuration shown in FIG. 3 differs from the construction shown in FIG. 2 only in that the sharpener blade 12 does not have a narrow rear face 26 which is parallel to the blade cutting edge 14, but the narrow rear face 26 and the blade cutting edge 14 include relative to each other an acute angle corresponding to the acute angle 22. This structure shown in FIG. 3 also provides that the clearance angle 18, which is constant along the conical sharpener passage 10, between the rear face of the sharpener blade 12 and the tangential face of the conical sharpener passage 10, is for example of the order of magnitude of 7° if the acute angle 22 is for example of the order of magnitude of 2°.

Identical features are identified in FIGS. 1 through 3 by the same respective references.

FIG. 4 is a diagrammatic view similar to FIGS. 1 through 3 showing a first embodiment of the sharpener according to the invention with a conical sharpener passage 10 and a sharpener blade 12, wherein the cutting edge 14 of the sharpener blade 12—as viewed in projection—includes with the sharpener passage 10 a clearance angle 18, 18′, 18″ which becomes continuously larger towards the tapering front end 20 of the sharpener passage, wherein 18′>18 and 18″>18′.

In the structure shown in FIG. 4 the cutting blade 12 is arranged displaced in relation to the longitudinal center line 16 of the conical sharpener passage 10 forwardly in the sharpening direction of rotation which is indicated by the arcuate arrow 28, in such a way that—as viewed in projection—the notional prolongation 30 of the blade cutting edge 14 intersects the longitudinal center line 16 of the sharpener passage 10 before the beginning 32 of the sharpener passage 10 at a small acute angle 34. That point of intersection is identified by reference numeral 36. As has already been mentioned above, this involves the projection of the blade cutting edge 14 or the notional prolongation 30 thereof into the corresponding plane (plane of the drawing) of the longitudinal center line 16.

As is readily apparent from the upper part of FIG. 4 in that way the clearance angle between the rear face of the sharpener blade 12 and the tangential surface of the conical sharpener passage 10 increases continuously from the beginning 32 towards the front end 20, as is clearly shown by the references 18<18′<18″.

FIG. 5 shows an embodiment of the sharpener according to the invention, which differs from the structure shown in FIG. 4 in that the cutting blade 12 is arranged in such a way that its blade cutting edge 14, in projection on to the longitudinal center line 16, intersects the longitudinal center line 16 of the conical sharpener passage 10 at the beginning 32 of the sharpener passage 10 at a small acute angle 34. That point of intersection is again identified by reference 36. Such an arrangement of the sharpener blade 12 or its cutting edge 14 in relation to the conical sharpener passage 10 also provides, as between the sharpener blade 12 and the conical sharpener passage 10, a clearance angle 18, 18′, 18″ which becomes continuously larger from the beginning 32 towards the front end 20 of the conical sharpener passage, with 18″>18′>18.

If for example the small acute angle 34 is of the order of magnitude of 2.5°, the clearance angle 18 is of the order of magnitude of 2.5°, the angle 18′ is of the order of magnitude of for example 11° and the angle 18″ is for example 22°. In comparison, in the structure shown in FIG. 4, with a small acute angle 34 of for example 2.5°, the clearance angles 18. 18′ and 18″ are: 18=4.3°; 18″=17° and 18″=36°.

FIG. 6 diagrammatically shows a configuration of the sharpener according to the invention, wherein the cutting edge 14 of the sharpener blade 12 is oriented in parallel relationship with the longitudinal center line 16 of the conical sharpener passage 10 and is displaced forwardly with respect to the longitudinal center line 16—as viewed in projection—laterally in the sharpening direction of rotation which is identified by reference numeral 28. That displacement is identified by reference numeral 38. Such a configuration also provides that the cutting edge 14 of the sharpener blade 12, with the sharpener passage 10, includes a clearance angle 18, 18′, 18″ which becomes continuously larger towards the tapering front end 20 of the sharpener passage, that is to say 18″>18′>18. For example the clearance angle 18=7°, the clearance angle 18′=15° and the clearance angle 18″=25°.

Adjoining the conical sharpener passage 10 at the rear end, that is to say at the beginning 32 thereof, is a per se known guide portion 40 which is of a constant diameter. Provided at the front end 20 of the conical sharpener passage 10 is a forming blade 42 which serves for forming the pasty lead 44 of the respective cosmetic soft lead pencil to be sharpened.

Identical features are denoted in FIGS. 4 through 6 by means of the same references and by means of the same references as in FIGS. 1 through 3 so that there is no need for all features to be respectively described in detail with reference to all the Figures.

1. A sharpener, in particular for cosmetic soft lead pencils, comprising a conical sharpener passage (10) and a sharpener blade (12) which is set approximately tangentially with respect to the sharpener passage (10) and which includes a clearance angle (18) with the sharpener passage (10),
characterised in that
the cutting edge (14) of the sharpener blade (12) includes with the longitudinal center line (16) of the conical sharpener passage (10)—as viewed in projection—an acute angle (34) which enlarges towards the front end (20) of the sharpener passage (10) so that the sharpener blade (12) includes with the sharpener passage (10) a clearance angle (18, 18′, 18″) which becomes continuously greater towards the tapering front end (20) of the sharpener passage (10).

2. A sharpener as set forth in claim 1 characterised in that the cutting blade (12) is arranged in such a way that the cutting edge (14) of the blade intersects the longitudinal center line (16) of the conically tapering sharpener passage (10)—as viewed in projection—at the beginning (32) of the sharpener passage (10) at a small acute angle (34).

3. A sharpener as set forth in claim 1 characterised in that the cutting blade (12) is arranged displaced forwardly in the sharpener direction of rotation (28) relative to the longitudinal center line (16) of the sharpener passage (10) in such a way that the notional prolongation (30) of the blade cutting edge (14) intersects the longitudinal center line (16) of the conically tapering sharpener passage (10)—as viewed in projection—before the beginning (32) of the sharpener passage (10) at a small acute angle (34).

4. A sharpener as set forth in one of claims 1 through 3 characterised in that a guide portion (40) of constant diameter adjoins the conical sharpener passage (10) at the rear end.

5. A sharpener as set forth in one of claims 1 through 4 characterised in that there is provided a forming blade (42) at the front end (20) of the conical sharpener passage (10).
